(19) United States
(12) Patent Application Publication
(10) Pub. No.: US 2006/0090863 A1
(43) Pub. Date: May 4, 2006

(54) Step-free roller blind arrangement

(75) Inventor: Roland Schneider, Ulm (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: BOS GmbH & Co. KG, Ostfildern (DE)

(21) Appl. No.: 11/262,389

(22) Filed: Oct. 28, 2005

(30) Foreign Application Priority Data
Oct. 28, 2004 (DE) 10 2004 052 479.3

(51) Int. Cl. B60J 1/20

(52) U.S. Cl. 160/370.22

(57) ABSTRACT

The cut edge of a roller blind that is fixed on a winding shaft produces an abrupt change in diameter. The radius of curvature of the wound blind abruptly changes at this location. The resulting bend in the roller blind predominantly stabilizes over time on the inner layers of the wound blind. When the roller blind is pulled out, the bend becomes visible in the form of a strip. In order to prevent this bend from forming, the outer surface of the roller blind transitions into a ramp surface in the winding shaft at the fixing point. The ramp surface can be produced by means of grinding, a filler body or use of a correspondingly stepped winding shaft.

### FIELD OF THE INVENTION

The present invention pertains to roller blind arrangements for motor vehicles.

### BACKGROUND OF THE INVENTION

The use of roller blind arrangements to cover the cargo areas of station wagons and the like is known. Such known roller blind arrangements include a winding shaft, generally defining a horizontal axis, which is rotatably mounted in the vehicle. One edge of a roller blind is fixed to the winding shaft. The roller blind consists of an opaque film material. The roller blind extends from the rear seat back to the rear edge of the vehicle cargo bay in the operating state.

In the pulled-out state, the roller blind is almost entirely unwound from the winding shaft. In practical applications, this means that no more than one layer of the roller blind remains wound on the winding shaft in order to protect the integral connection between the roller blind and the winding shaft from separating for safety reasons. Although the roller blind used in these applications is relatively thin, it has been found that the sharp cut edge of the roller blind that extends parallel to the winding shaft and that also remains on the winding shaft in the pulled-out state gradually leaves an impression on the wound layers. One or two impressions of the edge of the roller blind become visible on the extracted blind. These impressions can extend over the entire width of the roller blind producing an unattractive appearance.

This same problem also can occur with window or fixed-glass roller blinds in motor vehicles. In such cases, an edge strip of a thin perforated film or a knitted fabric is usually integrally connected to the winding shaft. The cut edge of the roller blind also leaves an impression through the protective layer remaining on the winding shaft that extends to layers that are visible in the pulled-out state of the window roller blind.

### BRIEF SUMMARY OF THE INVENTION

In view of the foregoing, a general object of the present invention is to develop a roller blind arrangement in which the edge of the roller blind that is connected to the winding shaft is prevented from producing a visible impression on the wound layers.

With roller blind arrangements, the steep, sharp cut edge of the roller blind that is connected to the winding shaft can be impressed on the underlying layers of the roller blind material because the cut edge causes the radius of the winding shaft to change abruptly and the roller blind is tightly stretched over this edge when it is wound on the winding shaft.

According to one embodiment of the present invention, the step created by the cut edge of the roller blind can be eliminated by means of a ramp surface. This ramp surface ensures that the outer surface of the roller blind no longer transitions abruptly in the outer circumferential surface of the winding shaft, but rather transitions relatively continuously. Thus, the difference in radii no longer consists of a steep step. The abrupt change produced by the steep step is eliminated by the ramp surface. Thus, a pressure point is no longer visibly impressed on the subsequent layers of the wound blind thereby preventing potential for an unattractive appearance of the pulled-out blind.

According to another embodiment of the invention, the effect of the sharp cut edge is eliminated by using a winding shaft with a generally spiraled cross sectional shape. With this arrangement, the step that is formed on the winding shaft has a height that corresponds approximately to the thickness of the roller blind. This eliminates any abrupt transitions and consequently also the impression of such a step on the layers of the overlying wound blind.

The ramp surface of the first embodiment can be achieved by grinding down the originally straight cut edge after the roller blind is bonded or otherwise fixed to the winding shaft, preferably by means of a grinding belt. This eliminates the step and creates a bevel such that the difference in radii is distributed over a corresponding angle. This also prevents the undesirable impression of a sharp edge on the overlying layers. Alternatively, the ramp surface can be provided by using a filler piece that is arranged in the inside corner between the cut edge of the roller blind and the outer circumferential surface of the winding shaft. This filler piece can consist of a preformed part. Such an arrangement solution is particularly advantageous if the step is relatively high, for example, if the roller blind is not bonded to the winding shaft but rather fixed thereto by means of a Keder welt Keder groove connection. The Keder groove creates a relatively wide, open gap that also tends to form an impression on the underlying layers. The material thickening created by the welt additionally increases the difference in radii.

The filler piece can lie loosely on the winding shaft or be integrally connected to the winding shaft. The filler piece can also be formed by the winding shaft itself. This provides the advantage of effectively eliminating the issue of manufacturing tolerances. For example, if the filler piece is applied in the form of a deformable mass that subsequently conformably hardens, the dimensions of the filler piece are automatically adapted to the respective circumstances. The filler piece can consist of hardenable materials such as hot melt adhesives, thermosetting resins (e.g., acrylic resins) as well as other materials with corresponding properties, i.e. initial plastic deformability and sufficient rigidity and thermal stability after the hardening and the attachment of the roller blind.

The inventive arrangements for preventing a step or a cut edge that is impressed on layers of the underlying wound blind can be used in connection with a cylindrical winding shaft, a winding shaft with a constant cross section over its length or a winding shaft with a cross section that changes from one end to the other end. When using a winding shaft with a spiraled cross section, a cone is thereby superimposed on the spiral relative to the length of the winding shaft. In the such an instance, the winding shaft is, in any case, realized conically or cylindrically.

The roller blind can consist of any suitable material, for example, a film or textile material in the form of a woven fabric or a nonductile knitted fabric. As mentioned above, the roller blind can be positively or integrally connected to the winding shaft. When using a positive connection, the ramp surface can be configured in the form of an inserted filler piece or a filler piece that is applied in the form of a deformable mass.

While reading through the following description of the figures, it becomes clear that the individual characteristics can be combined in many different ways. A detailed description of all these combinations would unnecessarily lengthen the description.

### BRIEF DESCRIPTION OF THE DRAWINGS

FIG. 1 is a schematic, partially cut away perspective view of a rear section of an illustrative motor vehicle having a rear wind roller blind according to the present invention.

FIG. 2 is a schematic plan view of the rear window roller blind of FIG. 1.

FIG. 3 is a schematic perspective view of a rear section of an illustrative station wagon equipped with a cargo area roller blind according to the present invention.

FIG. 4 is a schematic perspective view of the connection between the winding shaft and the roller blind in the roller blind arrangement of FIG. 2 and FIG. 3.

FIG. 5 is a schematic perspective view of a further embodiment of a filler piece for preventing the step created by the cut edge of the roller blind.

FIG. 6 is a schematic perspective view of another embodiment of the invention in which a step is prevented by grinding down the cut edge.

FIG. 7 is a schematic perspective view of another embodiment of the invention in which a step is prevented by the positive connection between the winding shaft and the roller blind.

FIG. 8 is a schematic perspective view of a further embodiment of the invention in which a step created by the beginning of the roller blind is prevented by using a winding shaft with spiral cross section.

### DETAILED DESCRIPTION OF THE INVENTION

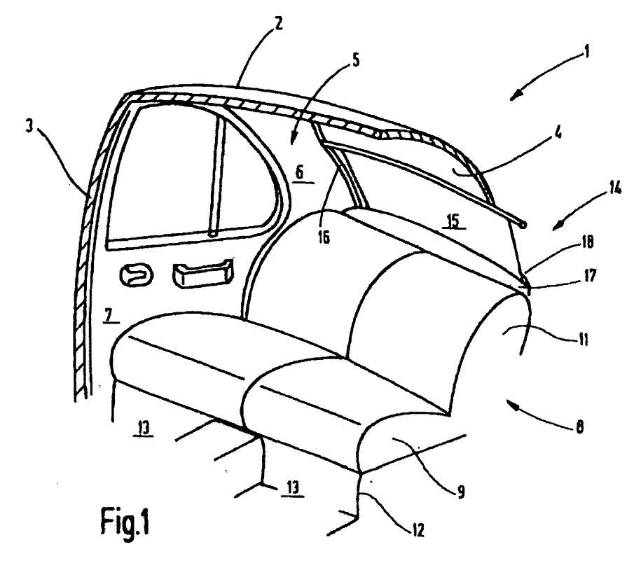

Referring now to FIG. 1 of the drawings, a rear section of an illustrative motor vehicle is shown. FIG. 1 shows a view of the right side of the interior, which is a mirror image of the left side of the interior (not shown). The illustration is simplified in certain respects. For example, interior structures of the car body such as reinforcements, mounting systems and the like are not shown because they are not essential for understanding the invention.

The illustrated car body section 1 includes a roof 2, from which a B column 3 laterally extends to a floor system. A corresponding B column is provided on the left side of the vehicle. At the rear edge of the roof, the roof 2 transitions into a rear window 4. The rear window 4 ends in the lateral direction at a C column 5 that is separated from the B column 3. The C column 5 carries an interior lining 6. A right rear side door 7 is conventionally hinged to the B column 3 between the B column 3 and the C column 5. A rear bench seat 8 with a seating surface 9 and a seat back 11 is located at the level of the right rear side door 7. The rear seating surface 9 lies on a pedestal surface 12 that forms part of the floor system and contains leg room areas 13 located in front of the rear seating surface 9.

A rear window roller blind 14 is provided in front of the inner side of the rear window 4. The partially extracted roller blind 15 and one of the two lateral guide rails 16 of the rear window roller blind 14 are shown in FIG. 1. The guide rail 16 begins at a rear window shelf 17 that is located behind the rear seat back 11 and extends adjacent to the lateral window edge. The rear window shelf 17 also contains a continuous extraction slot 18 through which the roller blind 15 can be extracted. The extraction slot 18 is curved to follow the curvature of the rear window 4.

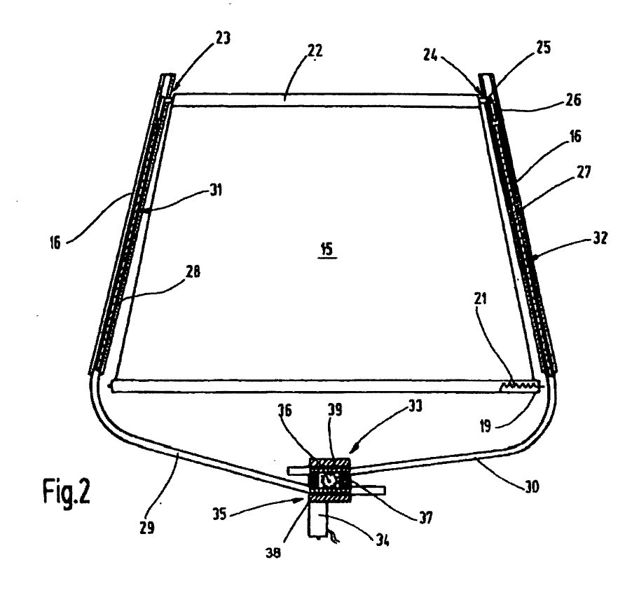

The basic design of the rear window shade 14 is illustrated in FIG. 2. A curved winding shaft 19 is rotatably supported underneath the rear window shelf 17, where one edge of the roller blind 15 is fixed to said winding shaft. The winding shaft 19 is prestressed in the direction in which the roller blind 15 is wound on the winding shaft 19 (e.g., with the aid of the schematically indicated spring drive 21). In the illustrated embodiment, the spring drive 21 comprises a coil spring that is rigidly anchored to the car body at one end and fixed in the winding shaft 19 at the other end.

The roller blind 15 is cut into an approximately trapezoidal shape and provided with a tubular loop 22 on its distal edge relative to the winding shaft 19. Guide pieces 23 and 24 are telescopically supported in an extraction profile or rod extending through the tubular loop 22. The guide pieces 23 and 24 comprise a neck part 25 that has a smaller diameter than an adjacent guide element 26 in the form of a short cylindrical section. The guide elements 26 move in guide rails 16 that are arranged adjacent to both lateral edges of the rear window 4.

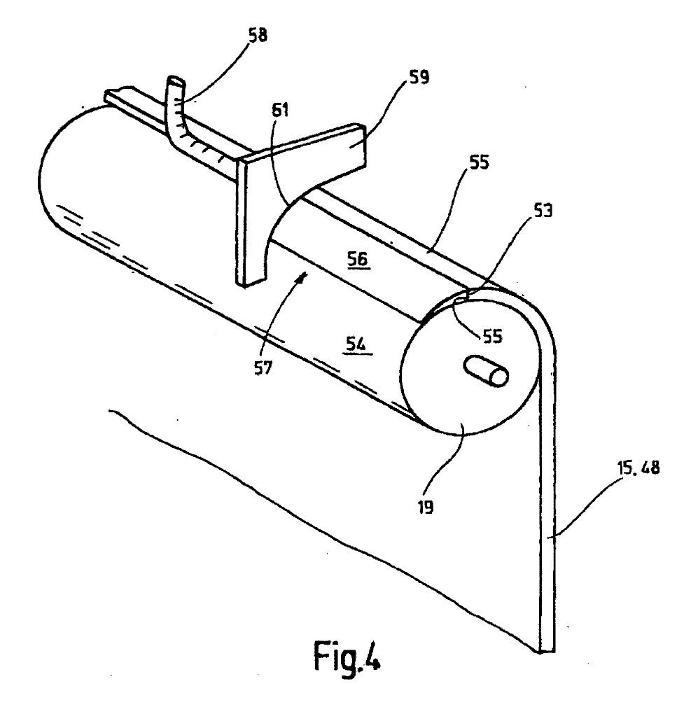

Each guide rail 16 contains a guide groove 27 in the form of a guide slot 28 that opens in the direction of the roller blind 15. The lower end of each guide rail 16 is connected to a guide tube 29, 30, in which two flexible thrust elements 31 and 32 are guided in buckle proof fashion. The flexible thrust elements 31 and 32 consist of so-called Suflex shafts that comprise a cylindrical core surrounded by a spirally extending rib. This configuration produces a flexible toothed rack with teeth over the entire periphery. The guide tubes 29 and 30 connect the guide rails 16 to a geared motor 33. The geared motor 33 consists of a permanently excited DC motor 34 and a gear 35. A cylindrical gear 37 is fixed without rotational play on an output shaft 36 of the gear 35. The gear 37 positively meshes with the two thrust elements 31 and 32. These thrust elements 31 and 32 tangentially extend past the cylindrical gear 37 on diametrically opposite sides and are guided in corresponding bores 38 and 39 for this purpose. When the geared motor 33 is set in motion, the thrust elements 31, 32 are selectively advanced or retracted. The guide pieces 23 and 24 follow the movement of the thrust elements 31, 32. The spring drive 21 presses these guide pieces against the free ends of the thrust elements 31, 32 located in the guide grooves 27. The roller blind 15 is fixed on the winding shaft 19 as described below with reference to FIGS. 4-8.

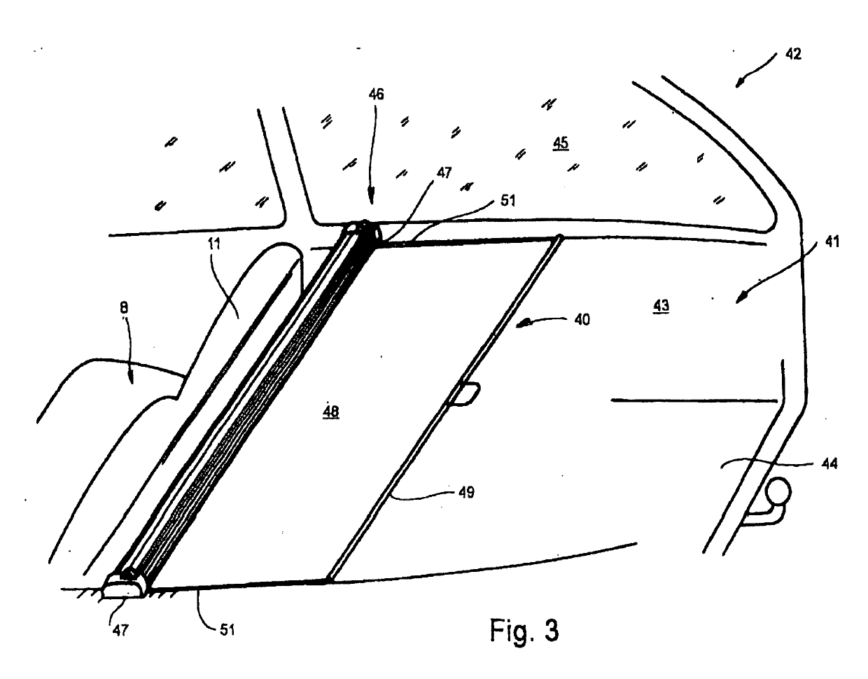

FIG. 3 shows a roller blind arrangement for a motor vehicle in the form of a roller cover 40 for the cargo bay 41 of a station wagon 42. The cargo bay 41 is limited by a first side wall 43, a second side wall that is a mirror image of the first side wall, as well as a floor 44. In the illustrated embodiment, a side window 45 is shown above the side wall 43. The front of the cargo bay is delimited by the seat back 11 of the rear bench seat 8.

The cargo roller cover 40 includes a removable elongated cassette 46 that is accommodated in lateral pockets 47 of the car body arranged underneath the side windows 45. The winding shaft is rotatably supported in the elongated cassette 46 with one edge of the roller blind 48 being fixed on the winding shaft. The winding shaft is prestressed in the winding direction of the roller blind 48 by means of a spring drive. The free end of the roller blind 48 is connected to a pull-out rod 49 that is guided in lateral guide rails 51 arranged underneath the side window 45.

The connection between the winding shaft 19 and the roller blind 15 or the roller blind 48 is illustrated in detail in FIG. 4. In this case, the thickness of the roller blind 15 is exaggerated in relation to the diameter of the winding shaft 19 in order to better illustrate the invention. As shown in FIG. 4, the roller blind 15 ends at a perpendicular cut edge 53 that creates a step in the cylindrical outer circumferential surface 54. The cut edge 53 forms an inside corner 55 together with the cylindrical outer circumferential surface 54.

If no precautionary measures are taken, the step created by the cut edge 53 can be impressed on the overlying layers of the roller blind 15 when the shade is wound up spirally on the winding shaft 19. A relatively sharp bend is created in the roller blind 15 at the abruptly changing diameter caused by the cut edge 53. This sharp bend stabilizes over time and eventually leads to a permanent deformation of the roller blind 15. In the pulled-out state, the altered light reflection causes this deformation to manifest itself in the form of an unattractive strip that continuously extends over the width of the roller blind 15 since the surface inclination of the roller blind 15 is changed relative to the incident light at this location. This unattractive deformation can remain visible up to the second or third layer of the wound blind.

According to an important aspect of the invention, a ramp surface 56 is provided in order to prevent the deformation caused by the cut edge 53. The ramp surface 56 ensures that the outer surface of the roller blind 15 (designated by reference symbol 57 in FIG. 4) extends over the ramp surface 56 without being bent by a step. The ramp surface 56 generally transitions into the outer circumferential surface 54 tangentially without a sharp bend. In the embodiment shown in FIG. 4, the ramp surface 56 is part of a filler piece 57. This filler piece 57 lies in the inside corner 55. In cross section, the filler piece 57 has the approximate shape of a curved triangle, one edge of which is an edge that lies parallel to the cut edge 53, the second edge of which lies on the outer circumferential surface 54, and the third edge of which is the ramp surface 56. The ramp surface 56 extends over the entire length of the winding shaft 15 and enables the original abrupt change in radii to be expanded over a section that corresponds to the length of the ramp surface 56 in the circumferential direction.

The filler piece 57 with the ramp surface 56 can be configured, for example, as schematically indicated in FIG. 4. In this case, the roller blind 15 is initially attached to the outer circumferential surface 54 along the cut edge 53 with the aid of a two sided adhesive tape. The cut edge 53 extends essentially along the surface line of the outer circumferential surface 54. The integral connection between the winding shaft 19 and the roller blind 15 that is produced with the aid of the adhesive tape extends, for example, over one fourth of the circumference of the winding shaft 19. A bead 58 (e.g., an acrylic resin, a hot melt adhesive or a two component adhesive) is then applied to the resulting inside corner 55 from the visible end face of the winding shaft 19. The bead 58 initially has an approximately cylindrical shape and is subsequently shaped into the desired filler body 57 by means of a blade 59. The blade 59 has a correspondingly curved edge 61, the shape of which corresponds to the curvature of the ramp surface 56 in the circumferential direction of the winding shaft 19. The blade 59 is guided over the entire bead 58 as schematically indicated in FIG. 4, i.e., from one end of the winding shaft 19 to the other. After applying and shaping the plastically deformable material, it is allowed to harden in order to create the desired filler body 57 that integrally adheres to the outer circumferential surface 54.

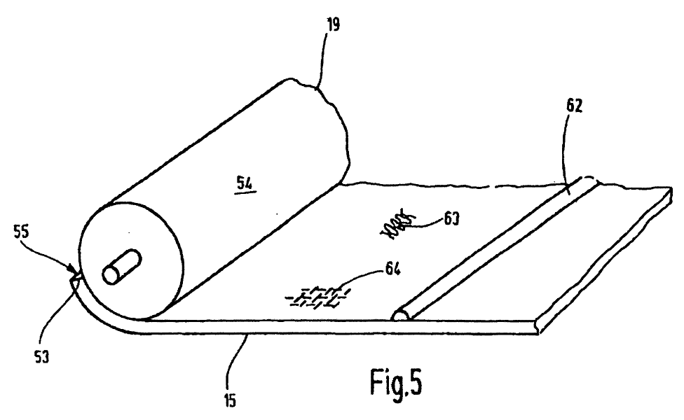

FIG. 5 shows another configuration for the filler body 57. As in the embodiment of FIG. 4, a certain section of the roller blind 15 is initially bonded to the outer circumferential surface 54 of the winding shaft 19. This also results in an inside corner 55 formed by the cut edge 53 and the outer circumferential surface 54. A straight bead 62 is applied over the entire width of the roller blind 15 at a distance from the cut edge 53 that corresponds to one layer of the roller blind 15 wound on the winding shaft 19. The bead 62 consists of the same material as the bead 58. The volume of the bead 62 is chosen such that it corresponds to the volume of the finished filler body 57.

Immediately after its application, the bead 62 has an approximately semicircular cross section because it flows in the width direction to a certain extent on the side of the roller blind 15, 48 that faces the outer circumferential surface 54. The roller blind 15, 48 is then wound on the winding shaft 19 such that the still plastic bead 62 is pressed into the inside corner 54 and a filler body 57 is created that has the approximate shape of the filler body 57 shown in FIG. 4. After the filler body has hardened or solidified, the roller blind is also integrally connected to the outer circumferential surface 54 of the winding shaft 19 in the region of the original bead 62 and consequently the inside corner 55.

According to FIG. 5, a film, a knitted fabric (indicated by reference symbol 63) or a woven fabric (indicated by reference symbol 64) may be used as the material for the roller blind 15. In all instances, a filler body 57 is used in order to prevent the straight, steep cut edge 53 from affecting the overlying layers of the wound blind.

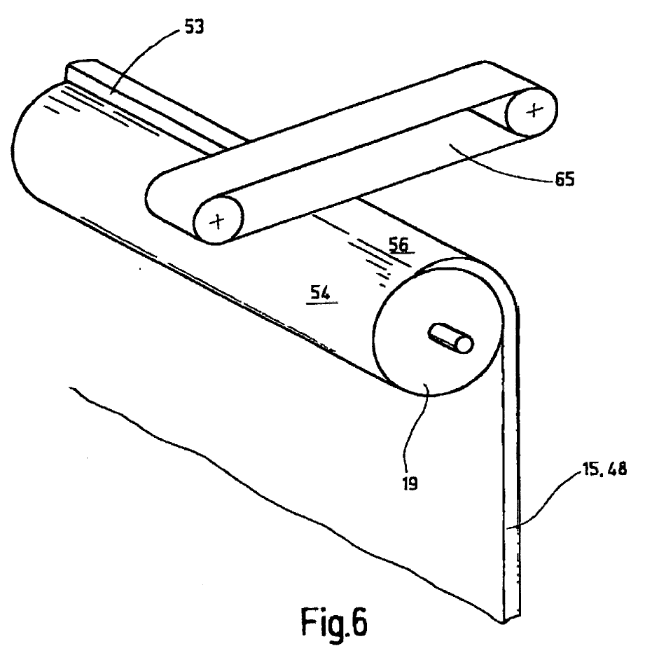

An alternative embodiment in which the ramp surface 56 is not a formed by one surface of a filler body or filler piece 57 is shown in FIG. 6. As described above, the roller blind 15 is integrally fixed on the outer circumferential surface 54 of the winding shaft 19 with the aid of a two sided adhesive tape or a hot melt adhesive. The cut edge 53 that extends parallel to the radius initially creates a step over the length of the winding shaft 19. After the roller blind 15 is fixed on the winding shaft 19, the cut edge 53 is ground down, for example, with the aid of a grinding belt 65. This grinding process causes the step due to the cut edge 53 to disappear. Once the roller blind 15, 48 is ground down, its end is tapered such that its outer side directly transitions into the outer circumferential surface 54 tangentially and thus without a step.

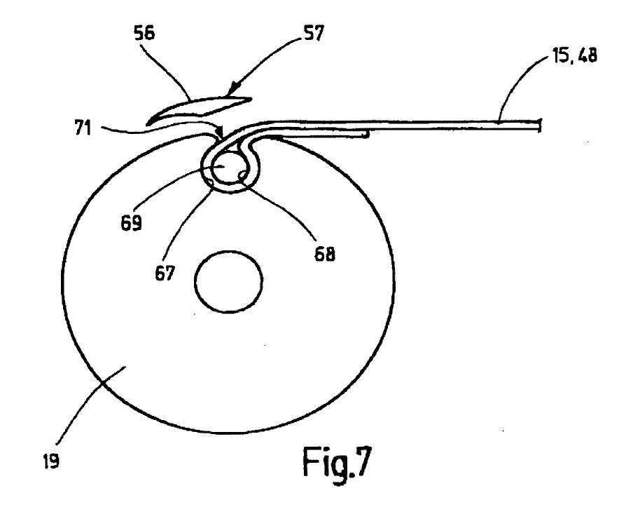

The utilization of the filler piece 57 according to FIG. 7 is not restricted to the integral connection between the roller blind 15 and the winding shaft 19. In the above described embodiments, the outer circumferential surface 54 has a cylindrically smooth or conically smooth configuration depending on the given application. In contrast, the winding shaft 19 of FIG. 7 includes a Keder groove 67 that continuously extends over its entire length. The respective edge of the roller blind 15 or 48 is provided with a Keder welt 68, in which a filler rod 69 is accommodated. The formed Keder is seated in the Keder groove 67 and the roller blind 15 or 48 respectively extends out of the Keder groove 67.

Due to the formation of a loop, the material is double layered in the immediate vicinity of the Keder groove 67 relative to the direction in which the layer progresses when the roller blind 15 or 48 is wound. FIG. 7 shows that this arrangement creates a more less broad and deep gap 71 that is limited by the edge of the Keder groove 67 on one side and by the outer side of the roller blind 15 or 48 on the other side. It has been found that this gap can also be imprinted on the subsequent layers of the roller blind 15 or 48 in an unattractive manner when it is wound on the winding shaft 19. A prefabricated filler piece 57 can be inserted into the gap 71 in order to prevent an impression from forming on the roller blind. The filler piece 57 forms the ramp surface 56 that serves for providing a gradual transition between the different diameters thereby preventing the step and the resultant bending deformation of the roller blind 15 or 48 in each layer wound over the gap.

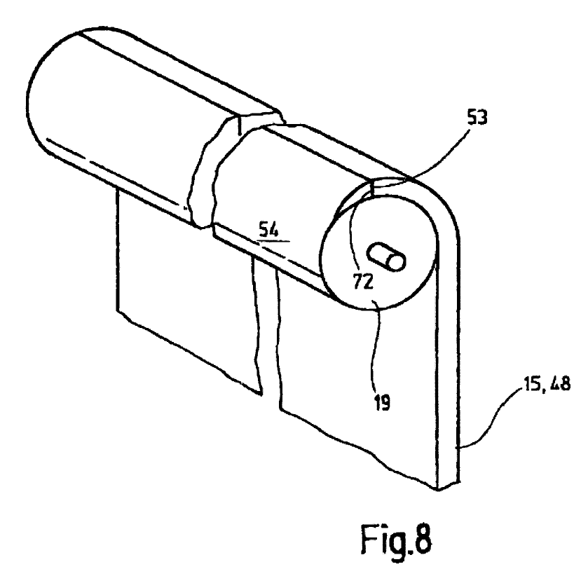

An embodiment in which the abrupt transition in the region of the cut edge 53 is prevented by using a winding shaft 19 with a cross section that at least approximately resembles a single Archimedes flight spiral is shown in FIG. 8. This arrangement results in an abrupt transition or step 72 in the outer circumferential surface 54 of the winding shaft 19 with the height of the step corresponding to the thickness of the roller blind 15 or 48. When the roller blind 15 or 48 is fixed on the outer circumferential surface 54 such that its cut edge 53 adjoins the step 52 as shown in FIG. 8, the outer circumferential surface makes a smooth transition into the outer surface of the roller blind 15 or 48 without an abrupt transition.

Those skilled in the art will readily appreciate that the described arrangements for preventing the step created by the perpendicular cut edge of the roller blind are by no means restricted to window roller blinds or cargo area roller blinds. These embodiments may be used with any type of roller blind in motor vehicles. In addition, the described arrangements are not necessarily restricted to cylindrical winding shafts. They may be used analogously in connection with winding shafts that are inherently conical and winding shafts in which a cone is produced by winding a triangular compensating section on an originally cylindrical winding shaft in order to simulate a conical winding shaft. This also results in a step that can be eliminated, for example, in accordance with FIG. 4.

The cut edge of a roller blind that is fixed on a winding shaft produces an abrupt change in diameter. The radius of curvature of the wound roller blind abruptly changes at this location. The resulting bend in the roller blind predominantly stabilizes over time on the inner layers of the wound blind. When the roller blind is pulled out, the bend becomes visible in the form of a strip. In order to prevent this bend from forming, the outer surface of the roller blind transitions into a ramp surface in the winding shaft at the fixing point. The ramp surface can be produced by means of grinding, a filler body or use of a correspondingly stepped winding shaft.

1. A roller blind arrangement for a motor vehicle comprising:
a winding shaft having a substantially rotationally symmetrical outer circumferential surface;
a roller blind fixed on the winding shaft along an edge of the roller blind, the roller blind having an inner surface that faces the winding shaft and an outer surface that faces away from the winding shaft; and
a ramp surface extending continuously over the length of the winding shaft from the outer circumferential surface of the winding shaft to the outer surface of the roller blind, the ramp surface pointing away from an axis of the winding shaft and being aligned in a non-parallel manner to a radius of the winding shaft extending through the ramp surface.

2. A roller blind arrangement according to claim 1, wherein the ramp surface comprises a ground down surface of the roller blind.

3. A roller blind arrangement according to claim 1, wherein the ramp surface comprises a surface of a filler piece that continuously extends over the length of the winding shaft and wherein a surface of the filler piece surface points away from the axis of the winding shaft.

4. A roller blind arrangement according to claim 3, wherein the filler piece comprises a prefabricated part.

5. A roller blind arrangement according to claim 3, wherein the filler piece comprises a part that is produced on the winding shaft and integrally connected to the winding shaft.

6. A roller blind arrangement according to claim 3, wherein the filler piece is integrally connected to the winding shaft and to the roller blind.

7. A roller blind arrangement according to claim 3, wherein the filler piece comprises a hardenable material.

8. A roller blind arrangement according to claim 1, wherein the cross sectional dimensions of the winding shaft change continuously from an end to an opposing end.

9. A roller blind arrangement according to claim 1, wherein the winding shaft is made of a metal or plastic material.

10. A roller blind arrangement according to claim 1, wherein the roller blind comprises a film.

11. A roller blind arrangement according to claim 1, wherein the roller blind comprises a textile material.

12. A roller blind arrangement according to claim 1, wherein the roller blind is integrally connected to the winding shaft.

13. A roller blind arrangement according to claim 1, wherein the roller blind is positively connected to the winding shaft.

14. A roller blind arrangement according to claim 13, wherein the winding shaft contains a groove in which a loop of the roller blind is anchored.

15. A roller blind arrangement for a motor vehicle comprising:
a winding shaft having a cross sectional shape that substantially corresponds to a single flight spiral with a continuous step over the length of the winding shaft at any point; and
a roller blind fixed on the winding shaft along an edge of the roller blind, the edge of the roller blind being arranged in an inside corner formed by the step, and the height of the step corresponding to the thickness of the roller blind at the edge of the roller blind.

16. A roller blind arrangement according to claim 15, wherein the cross sectional dimensions of the winding shaft change continuously from an end to an opposing end.

17. A roller blind arrangement according to claim 15, wherein the winding shaft is made of a metal or plastic material.

18. A roller blind arrangement according to claim 15, wherein the roller blind comprises a film.

19. A roller blind arrangement according to claim 15, wherein the roller blind comprises a textile material.

20. A roller blind arrangement according to claim 15, wherein the roller blind is integrally connected to the winding shaft.

21. A roller blind arrangement according to claim 15, wherein the roller blind is positively connected to the winding shaft.

22. A roller blind arrangement according to claim 21, wherein the winding shaft contains a groove in which a loop of the roller blind is anchored.
